(19) United States
(12) Patent Application Publication
(10) Pub. No.: US 2025/0282284 A1
(43) Pub. Date: Sep. 11, 2025

(54) APPARATUS, SYSTEM, AND METHOD FOR AUTOMATICALLY PROVIDING A REAR-END COLLISION MITIGATION ALERT

(71) Applicant: Toyota Motor Engineering & Manufacturing North America, Inc., Plano, TX (US)

(72) Inventors: Joseph T. Conners, Royal Oak, MI (US); Sushanth Kantharaj, Canton, MI (US); Jonathan G. Schuitema, Ann Arbor, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/597,729

(22) Filed: Mar. 6, 2024

(51) Int. Cl. B60Q 1/50; B60Q 1/44

(52) U.S. Cl. CPC B60Q 1/535; B60Q 1/444

(57) ABSTRACT

Apparatuses, systems, and methods for automatically providing a rear-end collision mitigation alert on a vehicle. The system includes a plurality of sensors configured to detect sensor data relating to the vehicle. The system also includes one or more light emitting apparatuses configured to emit light. The system further includes an electronic control unit (ECU) coupled to the plurality of sensors and the one or more light emitting apparatuses. The ECU may be configured to receive the sensor data from at least one sensor of the plurality of sensors and automatically activate at least one light emitting apparatus of the one or more light emitting apparatuses to oscillate between a first state and a second state at a predetermined frequency based on the sensor data indicating a prescribed condition for providing the rear-end collision mitigation alert.

### BACKGROUND

### Field

The present disclosure relates to apparatuses, systems, and methods for automatically providing a rear-end collision mitigation alert on a vehicle.

### Description of the Related Art

It is estimated that a high number of rear-end collisions (e.g., rear-end vehicle-to-vehicle collisions) take place in the United States every year and that a great number of people are injured (some fatally) due to these rear-end collisions.

While some technology such as rear cross-traffic alert (which alerts the driver of a subject vehicle of an imminent collision with a pedestrian or an object such as another vehicle at or near the rear side of the subject vehicle while the subject vehicle may be moving in a reverse direction at a relative low speed) or autonomous driving (which may include automatic evasive maneuver(s) when any imminent collision is detected) may be currently available, such technology is not readily available on many of the vehicles on the road at this time (e.g., because of the high cost associated with implementing such technology).

Moreover, some third-party after-market products providing an alert intended for a following vehicle behind a subject vehicle include, e.g., plug-in blinking brake lights which can be installed on a vehicle. However, such brake lights operate similarly to the original manufacturer brake lights except for a different “blinking” pattern (rather than, e.g., being specifically designed to operate only under a prescribed situation such as an emergency or a hard-braking situation that can possibly lead to a rear-end collision). That is, these plug-in brake lights may not alert anyone of a “true” emergency or hard-braking situation because they “blink” (e.g., oscillate between an on state and an off state) every time a driver applies their foot on a brake pedal rather than only for an emergency or hard-braking situation. With no discernable distinction between the “normal” braking and the hard-braking situations, these third-party after-market brake lights may cause more confusion and annoyance to drivers in following vehicles, rather than helping the drivers in the following vehicles specifically in an event where the probability of a rear-end collision between the subject vehicle and a following vehicle may be high.

Accordingly, there is a need for apparatuses, systems, and methods to automatically provide a rear-end collision mitigation alert on a vehicle (e.g., without significant added cost or hardware).

### SUMMARY

Described herein is a system for automatically providing a rear-end collision mitigation alert on a vehicle. The system may include a plurality of sensors. The plurality of sensors may be configured to detect sensor data relating to the vehicle. The system may include one or more light emitting apparatuses. The one or more light emitting apparatuses may be configured to emit light. The system may include an electronic control unit (ECU). The ECU may be coupled to the plurality of sensors and the one or more light emitting apparatuses. The ECU may be configured to receive the sensor data from at least one sensor of the plurality of sensors. The ECU may be configured to automatically activate at least one light emitting apparatus of the one or more light emitting apparatuses to oscillate between a first state and a second state at a predetermined frequency based on the sensor data indicating a prescribed condition for providing the rear-end collision mitigation alert.

Also described is an apparatus for automatically providing a rear-end collision mitigation alert on a vehicle. The apparatus may include one or more light emitting apparatuses. The one or more light emitting apparatuses may be configured to emit light. The apparatus may include a controller. The controller may be electrically coupled to the one or more light emitting apparatuses. The controller may be configured to receive an activation signal indicative of an instruction to activate at least one light emitting apparatus of the one or more light emitting apparatuses to oscillate between a first state and a second state at a predetermined frequency to provide the rear-end collision mitigation alert. The controller may be configured to automatically activate the at least one light emitting apparatus to oscillate between the first state and the second state at the predetermined frequency to provide the rear-end collision mitigation alert in response to the received activation signal.

Moreover, also described is a method for automatically providing a rear-end collision mitigation alert on a vehicle. The method may include detecting, via a plurality of sensors, sensor data relating to the vehicle. The method may include receiving, via an electronic control unit (ECU), the sensor data from the plurality of sensors. The method may include determining, via the ECU, a prescribed condition for providing the rear-end collision mitigation alert based on the received sensor data. The method may include automatically activating, via the ECU, at least one light emitting apparatus of one or more light emitting apparatuses to oscillate between a first state and a second state at a predetermined frequency in response to determining the prescribed condition for providing the rear-end collision mitigation alert.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating a vehicle having a system for automatically providing a rear-end collision mitigation alert on the vehicle according to an embodiment of the present invention;

FIG. 2 is a block diagram illustrating a system for automatically providing a rear-end collision mitigation alert on a vehicle according to an embodiment of the present invention;

FIG. 3 is an illustration of an example scenario for automatically providing a rear-end collision mitigation alert on a vehicle according to an embodiment of the present invention;

FIG. 4 is a block diagram illustrating a system for automatically providing a rear-end collision mitigation alert on a vehicle according to an embodiment of the present invention; and

FIG. 5 is a flowchart of a method for automatically providing a rear-end collision mitigation alert on a vehicle according to an embodiment of the present invention.

### DETAILED DESCRIPTION

The present disclosure describes apparatuses, systems, and methods for automatically providing a rear-end collision mitigation alert on a vehicle. The apparatuses, systems, and methods described herein provide many benefits and advantages including providing and automatically activating a rear-end collision mitigation alert on a vehicle without significant added cost. For example, the apparatuses, systems, and methods described herein may utilize one or more lights such as, e.g., one or more turn signals or brake lights to provide the rear-end collision mitigation alert on the vehicle (i.e., intended for a following vehicle) and take advantage of the processing being performed for, e.g., a forward-collision avoidance such that no significant additional resource is necessary.

The rear-end collision mitigation alert described herein may warn the following vehicle (including a driver of the following vehicle) to initiate braking such that the following vehicle may avoid rear-ending the vehicle providing the rear-end collision mitigation alert (also referred to herein as subject vehicle). The rear-end collision mitigation alert described herein may provide a visual warning not only to the driver of the following vehicle (e.g., potentially even when slightly distracted) but also to the following vehicle itself which may detect the rear-end collision mitigation alert via, e.g., its image-based assisted or autonomous driving system, even in the environment of relatively low visibility (e.g., when it is raining or relatively dark, etc. and the driver of the following vehicle may not be able to see the subject vehicle coming to a sudden stop, aggressively slowing down, or making an unexpected maneuver with naked eye as easily).

The apparatuses, systems, and methods described herein provide a technical solution for greatly reducing the number of rear-end collisions or the severity of such rear-end collisions by providing an alert or a warning to the drivers of following vehicles regarding, e.g., any hard or abnormal deceleration (i.e., outside of a predetermined range or greater than a threshold level) of a subject vehicle. Such an alert or a warning is intended to elicit or enable an improved brake response time and an improved estimation of the required brake force for the following vehicles (e.g., for the drivers of the following vehicles) to contribute to the mitigation of the rear-ending of the subject vehicle.

By utilizing faster (i.e., over a predetermined frequency) “blinking” (i.e., oscillating between a first state and a second state such as, respectively, an on state and an off state) hazard lights that automatically activate or turn on when a subject vehicle decelerates over a specified rate, the apparatuses, systems, and methods described herein can enable the subject vehicle to provide help to the driver of a following vehicle. That is, the driver of the following vehicle can react more quickly to a potential imminent collision between the subject vehicle and the following vehicle and start braking or applying other evasive maneuver(s) on the following vehicle earlier than would have been possible without such faster blinking hazard lights on the subject vehicle. For example, lights blinking faster than a specific frequency (e.g., 4 hertz (Hz)) can be recognized by even a peripheral vision of the driver of the following vehicle, making it easier to catch the attention of the driver of the following vehicle even when they may be at least slightly distracted. Moreover, the apparatuses, systems, and methods described herein may be made a part of a pre-existing collision avoidance system which may provide an alert or a warning and/or initiate or assist braking to avoid forward collisions of the subject vehicle, such that the foregoing benefits and advantages may be provided without significant added cost.

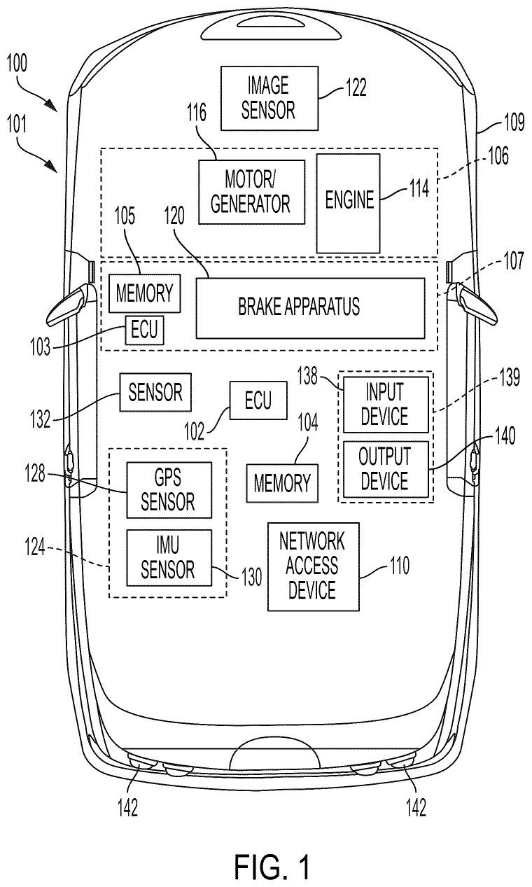

Turning to FIG. 1, a vehicle 100 is illustrated. The vehicle 100 may include a system 101 for automatically providing a rear-end collision mitigation alert on the vehicle 100. The vehicle 100 (or system 101) may include an electronic control unit (ECU) 102, a memory 104, a torque source 106, a brake system 107, a main body 109, and one or more light emitting apparatuses 142 (also may be referred to herein as one or more warning lights, turn signals, or the like). The vehicle 100 (or system 101) may further include a network access device 110, an image sensor 122, a location sensor 124, and one or more additional sensors 132. Moreover, the vehicle 100 (or system 101) may also include an input device 138 and an output device 140, which together may be referred to as a user interface 139.

As an aside, each of the components described herein may be or include an apparatus, a device, a system, a module (e.g., hardware or software), a circuitry, or the like configured to perform the disclosed operation(s).

In some embodiments, the main body 109 may be propelled along a roadway. The main body 109 may resemble a vehicle such as a car, a bus, a motorcycle, a sport utility vehicle (SUV), a truck, or the like and support one or more individuals such as a driver, a passenger, or the like. Furthermore, the main body 109 may define or include a vehicle cabin in which the driver, the passenger, or the like may be located. The vehicle 100 having the main body 109 may be any type of vehicle known in the art configured to transport, e.g., a vehicle occupant (e.g., a driver or a passenger) within the main body 109 and propelled by an engine, a motor, or the like, while being, e.g., at least partially (or fully) powered by fuel or electricity and, in some embodiments, including at least an energy storage device such as a battery.

The ECU 102 disposed on or within the vehicle 100 may be coupled to each of various components of (e.g., on or within) the vehicle 100 and may include one or more processors or controllers which may be specifically designed and programmed for automotive systems. The functions of the ECU 102 may be implemented in a single ECU or in multiple ECUs. For example, the ECU 102 may include or may be coupled to a torque ECU that controls the torque source 106, a user interface ECU that controls the user interface 139, or the like. The ECU 102 may receive data from one or more of the components of the vehicle 100, may make determinations based on the received data, and may control the operations of the one or more of the components based on the determinations. For example, the ECU 102 may receive a brake request from a brake pedal, may determine a brake operation based on the received brake request, and may cause one or more components of the brake system 107 (e.g., a brake apparatus 120) to be actuated so as to, e.g., slow down or stop movement of the vehicle 100. The ECU 102 and/or a brake system ECU 103 included in the brake system 107 may also be configured to determine, e.g., whether to initiate or assist a braking effort based on sensor data (e.g., detected by one or more of the various types of sensors described herein).

The vehicle 100 may be non-autonomous, fully autonomous, or semi-autonomous. In that regard, the ECU 102 may control various aspects of the vehicle 100 (such as steering, braking, accelerating, or the like) to maneuver the vehicle 100 from a starting location to a destination location. In some embodiments, the vehicle 100 may be operated in an autonomous, semi-autonomous, or fully driver-operated state. In that regard, the vehicle 100 may be operated independently of driver control and, from time to time, without a person inside of the vehicle 100. The ECU 102 may facilitate autonomous functionality.

The brake system ECU 103 may be coupled to each component of or within the brake system 107 and may include one or more processors or controllers which may be specifically designed and programmed for automotive systems. The functions of the brake system ECU 103 (e.g., a dedicated ECU for the brake system 107) may be implemented in a single ECU or in multiple ECUs. The brake system ECU 103 may monitor and/or control the brake system 107 to, e.g., initiate or assist a panic braking (also may be referred to herein as an emergency braking) and/or a forward collision avoidance system by controlling or actuating one or more components of the brake apparatus 120. In some embodiments, the brake system ECU 103 may cooperate with the ECU 102 or solely operate to control the brake system 107.

The memory 104 may store a plurality of instructions to be executed by the ECU 102 and may include one or more of a RAM (Random Access Memory) or other volatile or non-volatile memory. The memory 104 may be a non-transitory memory or a data storage device, such as a hard disk drive, a solid-state disk drive, a hybrid disk drive, or other appropriate data storage, and may further store machine-readable instructions, which may be loaded and executed by the ECU 102. The memory 104 may include any non-transitory memory and may store data usable by the ECU 102. The memory 104 may be located in or on the main body 109 and may be referred to as a local memory. In some embodiments, the memory 104 may be located remotely from the main body 109 and may be referred to as a remote memory.

In some embodiments, the brake system 107 may include a non-transitory memory—a brake system memory 105—that may be the same as or separate from the memory 104. The brake system memory 105 may store data usable by the brake system ECU 103 to monitor and/or control operations of the brake system 107.

The torque source 106 may include one or more of an engine 114 or a motor-generator 116. As referenced herein, the ECU 102 may monitor and/or control operation of the torque source 106 (including the engine 114 and/or the motor-generator 116).

The engine 114 may convert a fuel into mechanical power for propelling the vehicle 100. In that regard, the engine 114 may be a gasoline engine, a diesel engine, an ethanol engine, or the like. Optionally, the vehicle 100 may not include the engine 114 and may be an electric vehicle with the motor-generator 116.

The motor-generator 116 may convert, e.g., electrical energy stored in an energy storage device (e.g., including one or more energy storage devices such as a battery, a flywheel, a super capacitor, a thermal storage device, or the like) or received directly from, e.g., a fuel-cell circuit (e.g., including a plurality of fuel cells (e.g., one or more fuel cell stacks) that facilitate a chemical reaction to generate electrical energy along with a system or systems for providing hydrogen and oxygen (or any other compounds as needed)) into mechanical power usable to propel the vehicle 100. The motor-generator 116 may further convert mechanical power received from the engine 114 or from wheels of the vehicle 100 into electricity, which may be stored in the energy storage device as energy and/or used by other components of the vehicle 100. In some embodiments, the motor-generator 116 may include a motor without a generator portion, and, in some embodiments, a separate generator may be provided.

The brake apparatus 120 may include a brake pad, one or more pistons configured to push the brake pad against a rotor connected to a wheel of the vehicle 100 to slow down or stop movement of the rotor (and that of the wheel), and a brake pedal (which, in some embodiments, may also or alternatively be part of the input device 138) for causing, e.g., the one or more pistons to be actuated. The brake apparatus 120 may include, e.g., disc-type brakes, drum-type brakes, or the like, as would be apparent to one or ordinary skill in the art and usable with various embodiments described herein.

The location sensor 124 may include any sensor capable of detecting location data corresponding to a location of the vehicle 100. For example, the location sensor 124 may include one or more of a global positioning system (GPS) sensor 128, an inertial measurement unit (IMU) sensor 130, or the like. The GPS sensor 128 may detect data corresponding to a location of the vehicle 100. For example, the GPS sensor 128 may detect global positioning coordinates of the vehicle 100. The IMU sensor 130 may include one or more of an accelerometer, a gyroscope, or the like. The IMU sensor 130 may detect inertial data corresponding to a position, a velocity, an orientation, an acceleration, or the like of the vehicle 100. The inertial data may be used to identify a change in location of the vehicle 100, which the ECU 102 may track in order to determine the location of the vehicle 100.

The image sensor 122 may be connected to the main body 109 and may detect image data corresponding to an environment of the vehicle 100, data corresponding to a vehicle cabin, or the like. For example, the image sensor 122 may include a camera, a RADAR detector, a LIDAR detector, or any other image sensor capable of detecting light having any wavelength. The image sensor 122 may include one or multiple image sensors which may be oriented to detect image data in any direction relative to the main body 109 (and/or within the vehicle cabin). For example, the image sensor 122 may include four or more RADAR detectors to detect RADAR data on four or more sides of the main body 109. The image sensor 122 may also or alternatively include a first camera to detect image data in a forward direction relative to the main body 109 and a second camera to detect image data in a rear direction relative to the main body 109, etc.

The one or more additional sensors 132 may include one or more sensors capable of detecting a status of a vehicle component. For example, the one or more additional sensors 132 may include a voltage sensor, a current sensor, a power sensor, an SOC (state-of-charge) sensor, a brake sensor, or the like. In one example, the brake sensor (i.e., of the one or more additional sensors 132) may detect braking data corresponding to or including a level of instantaneous force applied on a brake pedal on the vehicle 100.

The input device 138 may include one or more input devices such as a button, a keyboard, a mouse, a touchscreen, a microphone, or the like. The input device 138 may receive input from a user of the vehicle 100 such as a driver or a passenger. The input device 138 may receive, for example, information corresponding to a request for cruise control, information usable to control an auxiliary component of the vehicle 100 (e.g., to control a navigation device or a stereo), or the like. In some embodiments, the input device 138 may include additional input device(s) usable to control the vehicle 100 such as an accelerator pedal, a brake pedal, a steering wheel, or the like. The input device 138 may also or alternatively receive information corresponding to a request for the vehicle 100 to be driven autonomously.

The output device 140 may include any output device such as a speaker, a display, a touchscreen, or the like. The output device 140 may output data to a user of the vehicle. The output device 140 may, for example, output information corresponding to autonomous control or other operation(s) of the vehicle 100. In some embodiments, the output device 140 may also or alternatively output a warning or an alert (e.g., a warning notification) intended for an audience outside of the vehicle 100. In that regard, the output device 140 may also or alternatively include the one or more light emitting apparatuses 142.

The one or more light emitting apparatuses 142 may be or include one or more light emitting components such as lamps configured to emit a light of a specific wavelength and may be disposed on or within the main body 109 (e.g., on a rear side of the vehicle 100). For examples, the one or more light emitting apparatuses 142 may be or include one or more turn signal lights such as a left turn signal light, a right turn signal light, or the like for providing an indication of an intention for the vehicle 100 to turn or move in a lateral direction (i.e., left or right). In some embodiments, the one or more light emitting apparatuses 142 may also or alternatively be or include one or more brake lights for providing an indication of an intention for the vehicle 100 to slow down or come to a stop. The one or more light emitting apparatuses 142 may be activated to turn on or off or emit a light of various wavelengths and/or intensities. As described herein, the one or more light emitting apparatuses 142 may be configured or activated to oscillate between a first state and a second state (i.e., “blink”) at a predetermined frequency—e.g., based on sensor data indicating a prescribed condition for providing a rear-end collision mitigation alert. The blinking of the one or more light emitting apparatuses 142 may be the rear-end collision mitigation alert intended for a following vehicle or a driver operating the following vehicle to recognize as a warning notification or signal to initiate braking and/or evasive maneuver(s) on the following vehicle.

The network access device 110 may include any network access device capable of communicating via a communications protocol (e.g., a wireless protocol). For example, the network access device 110 may include a transceiver and communicate via Bluetooth, Wi-Fi, a cellular protocol, or any other communications (e.g., wireless) protocol. The network access device 110 may be referred to as a data communication module (DCM) and may communicate with any device on the vehicle 100 and/or any remote device.

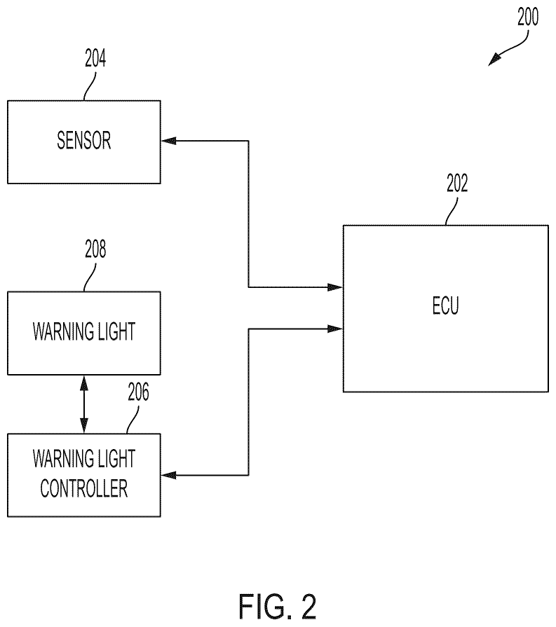

FIG. 2 is a block diagram illustrating a system (or apparatus) 200 for automatically providing a rear-end collision mitigation alert on a vehicle (e.g., similar to the vehicle 100 shown in and described herein with respect to FIG. 1). The system 200 may include an ECU 202 (e.g., similar to the ECU 102 shown in and described herein with respect to FIG. 1), one or more sensors 204 (e.g., similar to at least one of the image sensor 122, the location sensor 124, or the one or more additional sensors 132 (i.e., including the brake sensor) shown in and described herein with respect to FIG. 1), a warning light controller 206, and one or more warning lights 208 (e.g., similar to the one or more light emitting apparatuses 142 shown in and described herein with respect to FIG. 1).

As shown, the ECU 202 may be coupled or connected to or in data communication with the one or more sensors 204. Moreover, the ECU 202 may be coupled or connected to or in data communication with the warning light controller 206. The warning light controller 206 may include or couple to one or more processors. These one or more processors may be implemented as a single processor or as multiple processors. For example, the warning light controller 206 may be or include a microprocessor, a data processor, a microcontroller, or other controller, and may be coupled (e.g., electrically) to at least the one or more warning lights 208 and configured to activate, actuate, or otherwise control at least the one or more warning lights 208. The warning light controller 206 may be a dedicated processor or controller for the system 200 or may be coupled to or be a part of another apparatus or system which controls other devices or perform different or additional operations, too. For example, the warning light controller 206 may be included in or may be a part of the ECU 202. In some embodiments, the warning light controller 206 may receive an activation signal (e.g., from the ECU 202) indicative of an instruction to activate at least one of the one or more warning lights 208 to blink at a predetermined frequency to provide the rear-end collision mitigation alert and may automatically activate at least one of the one or more warning lights 208 to blink at the predetermined frequency to provide the rear-end collision mitigation alert in response to the received activation signal.

As described herein with respect to, e.g., the image sensor 122, the location sensor 124, and the one or more additional sensors 132 (i.e., including the brake sensor) with reference to FIG. 1, the one or more sensors 204 may be configured to detect various types of sensor data relating to the vehicle such as image data of the surrounding environment or a vehicle cabin of the vehicle, location data of the vehicle, braking data of the vehicle, proximity data of one or more objects within the surrounding environment of the vehicle, etc.

Moreover, as described herein with respect to the one or more light emitting apparatuses 142 with reference to FIG. 1, the one or more warning lights 208 may be or include one or more light emitting components such as lamps configured to emit a light of a specific wavelength and may be disposed on or within the main body of the vehicle (e.g., on a rear side of the vehicle). For examples, the one or more warning lights 208 may be or include one or more turn signal lights such as a left turn signal light, a right turn signal light, or the like for providing an indication of an intention for the vehicle to turn or move in a lateral direction (i.e., left or right). In some embodiments, the one or more warning lights 208 may also or alternatively be or include one or more brake lights for providing an indication of an intention for the vehicle to slow down or come to a stop. The one or more warning lights 208 may be activated to turn on or off or emit a light of various wavelengths and/or intensities. The one or more warning lights 208 may be configured or activated to blink at a predetermined frequency—e.g., based on the sensor data indicating a prescribed condition for providing a rear-end collision mitigation alert. The blinking of the one or more warning lights 208 may be the rear-end collision mitigation alert intended for a following vehicle or a driver operating the following vehicle to recognize as a warning notification or signal to initiate braking and/or evasive maneuver(s) on the following vehicle.

In various embodiments, the ECU 202 may be configured to receive the sensor data from at least one sensor of the one or more sensors 204. The ECU 202 may further be configured to automatically activate (e.g., via the warning light controller 206) at least one warning light of the one or more warning lights 208 to blink at a predetermined frequency based on the sensor data indicating a prescribed condition for providing the rear-end collision mitigation alert.

In order to determine the prescribed condition for providing the rear-end collision mitigation alert, the ECU 202 may be configured to determine a time to collision (TTC) of the vehicle with an object based on the sensor data and determine that the sensor data indicates the prescribed condition based on the determined TTC being less than a threshold value. For example, the ECU 202 may determine a current location, a speed, and a direction of travel of a subject vehicle (e.g., based on the location data and/or the inertial data) and a location of (and/or a distance to) an object such as another vehicle positioned in the direction of travel of the subject vehicle (as well as a speed and a direction of travel of the another vehicle if the another vehicle is moving) based on, e.g., at least the image data. Then, the ECU 202 may determine (e.g., estimate or predict) the TTC of the subject vehicle with the object in the direction of travel of the subject vehicle based on the determined current location, the speed, and the direction of travel of the subject vehicle and the determined location of the object (as well as the determined speed and the determined direction of travel of the object if the object is moving)—i.e., by determining when the subject vehicle is estimated or predicted (i.e., expected) to run into the object.

Then, the ECU 202 may compare the determined TTC of the subject vehicle with the object against a threshold value. In various embodiments, there may be one or more threshold values. A first threshold value for the TTC may indicate that the subject vehicle is expected to run into the object within a first given amount of time that may automatically trigger or activate a “panic braking” of the subject vehicle. When the panic braking is triggered or activated for the subject vehicle, the ECU 202 may apply a maximum allowed level of instantaneous braking force on the subject vehicle to attempt to slow down or stop the subject vehicle such that, e.g., the subject vehicle does not collide with the object.

A second threshold value for the TTC may indicate that the subject vehicle is expected to run into the object within a second given amount of time (e.g., which is greater than the first given amount of time) that may automatically trigger or activate a “pre-brake assistance” of the subject vehicle. When the pre-brake assistance is triggered or activated for the subject vehicle, the ECU 202 may apply a predetermined level of instantaneous braking force which may be less than the maximum allowed level of instantaneous braking force on the subject vehicle, e.g., to supplement an amount of braking force which may originate or may be expected to originate from the driver of the subject vehicle who may still have an opportunity to apply some instantaneous braking force via, e.g., the brake pedal on the subject vehicle in an effort to slow down or stop the subject vehicle such that the subject vehicle does not collide with the object. The supplemental amount of instantaneous braking force to be applied on the subject vehicle via the pre-brake assistance may be a predetermined value based on, e.g., a manufacturer setting or a learned value for the subject vehicle based on a driving history related to the subject vehicle and/or the driver of the subject vehicle (e.g., related to an amount of instantaneous braking force applied based on user input—e.g., received via the input device 138 shown in and described herein with respect to FIG. 1, such as a brake pedal—from the driver of the subject vehicle or other vehicle(s) of the same type or model as the subject vehicle at the TTC having the second threshold value.

A third threshold value for the TTC may indicate that the subject vehicle is expected to run into the object within a third given amount of time (which is greater than the first given amount of time and the second given amount of time) that may automatically trigger or activate a “forward-collision warning system” of the subject vehicle. When the forward-collision warning system is triggered or activated for the subject vehicle, the ECU 202 may predict that the subject vehicle is expected to run into the object within the third given amount of time and provide a warning notification (e.g., via the output device 140 shown in and described herein with respect to FIG. 1) such that the driver of the subject vehicle may start to apply a braking force on the subject vehicle upon receiving the warning notification to attempt to slow down or stop the subject vehicle such that the subject vehicle does not collide with the object.

A fourth threshold value for the TTC may provide a prescribed condition for triggering or activating the rear-end collision mitigation alert described herein. In some embodiments, the fourth threshold value for the TTC may be the same as the third threshold value for the TTC described herein as automatically triggering or activating the forward-collision warning system. In such embodiments, the subject vehicle can provide a warning to the following vehicle or the driver of the following vehicle via the rear-end collision mitigation alert substantially simultaneously as the driver of the subject vehicle is given a warning via the forward-collision warning system. In this way, the subject vehicle can provide the rear-end collision mitigation alert for the following vehicle early and before any rear-end collision occurs—that is, even before, e.g., the pre-brake assistance or the panic braking is triggered or activated. In some embodiments, the fourth threshold value for the TTC may be even greater than the third threshold value for the TTC (e.g., by a prescribed amount) such that the rear-end collision mitigation alert may be automatically triggered or activated even before the forward-collision warning system is triggered or activated.

Furthermore, in some embodiments, the fourth threshold value for the TTC may be the same as or greater (i.e., by the prescribed amount) than the second threshold value for the TTC or the first threshold value for the TTC. For example, when the forward-collision warning system is not available on the subject vehicle, the fourth threshold value for the TTC (i.e., for triggering or activating the rear-end collision mitigation alert) may be the same as or greater (i.e., by the prescribed amount) than the second threshold value for the TTC (for the pre-brake assistance), and when the forward-collision warning system and the pre-brake assistance are not available on the subject vehicle, the fourth threshold value for the TTC may be the same as or greater (i.e., by the prescribed amount) than the first threshold value for the TTC (for the panic braking). In some embodiments, the fourth threshold value for the TTC for automatically triggering or activating the rear-end collision mitigation alert may be a predetermined value (e.g., based on a manufacturer setting) unrelated to other threshold values for the TTC.

In addition or alternatively, to determine the prescribed condition for providing the rear-end collision mitigation alert, the ECU 202 may be configured to determine a rate of deceleration of the subject vehicle based on the sensor data and determine that the sensor data indicates the prescribed condition based on the determined rate of deceleration of the subject vehicle being greater than a threshold rate of deceleration. For example, the ECU 202 may determine a current location, a speed, and a direction of travel of the subject vehicle, e.g., based on the location data and/or the inertial data. Then, the ECU 202 may determine the rate of deceleration of the subject vehicle based on the determined current location, the speed, and the direction of travel of the subject vehicle.

The ECU 202 may compare the determined rate of deceleration of the subject vehicle against a threshold rate of deceleration. There may be one or more threshold deceleration rates. A first threshold deceleration rate of the subject vehicle may indicate a first level of urgency in the subject vehicle being slowed down or brought to a stop (e.g., when the panic braking is available on the subject vehicle). For example, the first threshold deceleration rate may indicate that the subject vehicle (via the driver's application of force on the brake pedal or an autonomous maneuver of the subject vehicle) is attempting to sufficiently slow down (i.e., to avoid a collision with an object) or stop within a first given amount of time corresponding to the first level of urgency. In some embodiments, the amount of the force (i.e., an instantaneous force) applied on the brake pedal by the driver (e.g., greater than a first threshold level of force) in this scenario (e.g., as determined based on the braking data detected by the brake sensor) may also or alternatively be an indication of the prescribed condition for providing the rear-end collision mitigation alert. The first level of urgency may correspond to a level of emergency scenario that triggers or activates the panic braking.

A second threshold deceleration rate of the subject vehicle may indicate a second level of urgency in the subject vehicle being slowed down or brought to a stop (e.g., when the pre-brake assistance is available on the subject vehicle). For example, the second threshold deceleration rate may indicate that the subject vehicle (via the driver's application of force on the brake pedal or an autonomous maneuver of the subject vehicle) is attempting to sufficiently slow down (i.e., to avoid a collision with an object) or stop within a second given amount of time (greater than the first given amount of time) corresponding to the second level of urgency (lower than the first level of urgency). In some embodiments, the amount of the force (i.e., an instantaneous force) applied on the brake pedal by the driver (e.g., greater than a second threshold level of force and at or below the first threshold level of force) in this scenario (e.g., as determined based on the braking data detected by the brake sensor) may also or alternatively be an indication of the prescribed condition for providing the rear-end collision mitigation alert. The second level of urgency may correspond to a level of emergency scenario that triggers or activates the pre-brake assistance.

A third threshold deceleration rate of the subject vehicle may indicate a third level of urgency in the subject vehicle being slowed down or brought to a stop (e.g., when the forward-collision warning system is available on the subject vehicle). For example, the third threshold deceleration rate may indicate that the subject vehicle (via the driver's application of force on the brake pedal or an autonomous maneuver of the subject vehicle) is attempting to sufficiently slow down (i.e., to avoid a collision with an object) or stop within a third given amount of time (greater than the second given amount of time) corresponding to the third level of urgency (lower than the second level of urgency). In some embodiments, the amount of the force (i.e., an instantaneous force) applied on the brake pedal by the driver (e.g., greater than a third threshold level of force and at or below the second threshold level of force) in this scenario (e.g., as determined based on the braking data detected by the brake sensor) may also or alternatively be an indication of the prescribed condition for providing the rear-end collision mitigation alert. The third level of urgency may correspond to a level of emergency scenario that triggers or activates the forward-collision warning system.

In various embodiments, each of, as well as various combinations of, the determination of the TTC, the determination of the rate of deceleration of the subject vehicle, and the determination of the level of instantaneous force applied on the brake pedal on the subject vehicle may be a basis for the ECU 202 to determine that there is a prescribed condition for automatically providing a rear-end collision mitigation alert on the subject vehicle (i.e., based on the sensor data). One or more of the threshold values described herein may automatically trigger or activate the rear-end collision mitigation alert. When the prescribed condition for automatically providing the rear-end collision mitigation alert is no longer met (e.g., based on one or more—e.g., all—of the threshold values discussed herein no longer being met), the rear-end collision mitigation alert may automatically stop.

As described herein, the one or more warning lights 208 may be configured or activated to blink at a predetermined frequency—e.g., based on the sensor data indicating a prescribed condition for providing a rear-end collision mitigation alert—to provide the rear-end collision mitigation alert. The blinking of the one or more warning lights 208 may include an oscillation of the one or more warning lights 208 (individually, by group-synchronously or asynchronously, or the like) between a first state and a second state at the predetermined frequency. The blinking of the one or more warning lights 208 at the predetermined frequency (e.g., including variations in frequency and/or wavelength, etc. and/or combinations of various ones of the one or more warning lights 208 respectively corresponding to various levels of urgency described herein) may be controlled by the warning light controller 206. The blinking may be controlled such that it is adjusted to the variation and/or the combination that results in the best indication of the attention of the following vehicle or the driver of the following vehicle being caught-such as, e.g., based on the greatest distance between the following vehicle and the subject vehicle being achieved when both vehicles are stopped.

Relevant information (e.g., historical data of the distances between the following vehicle and the subject vehicle when both vehicles are stopped after the activation of the rear-end collision mitigation alert) may be collected by the subject vehicle (e.g., via at least one sensor of the one or more sensors 204 detecting the distance between the following vehicle and the subject vehicle after each activation of the rear-end collision mitigation alert) and maintained by the subject vehicle (e.g., on a memory similar to the memory 104 shown in and described herein with respect to FIG. 1). In addition or alternatively, such data may be communicated to (e.g., via a network access device similar to the network access device 110 shown in and described herein with respect to FIG. 1) and maintained by a remote server in data communication with the subject vehicle, and the remote server may collect and maintain similar data from not only the subject vehicle but also from other vehicles. In some embodiments, such data as maintained by the remote server may be categorized based on metadata associated with the vehicle(s) providing such data-such as, e.g., vehicle type or model or identity of the driver.

In some embodiments, the first state and the second state of the one or more warning lights 208 may be an on state corresponding to a light being emitted and an off state corresponding to the light not being emitted, respectively. Moreover, in some embodiments, the one or more warning lights 208 in the first state may emit a light of a first level of brightness, and the one or more warning lights 208 in the second state may emit a light of a second level of brightness different from the first level of brightness.

In various embodiments, the predetermined frequency at which the one or more warning lights 208 blink may be based on a manufacturer setting and at least a threshold level of frequency. For example, the predetermined frequency may be at least 4 hertz (Hz). The threshold level of frequency of the blinking of the one or more warning lights 208 may be designed to increase or improve visibility or detectability of the light emitted by the one or more warning lights 208. For example, the threshold level of frequency of the blinking of the one or more warning lights 208 may correspond to a level designed to help the light from the one or more warning lights 208 be recognized even by a peripheral vision of the driver in a following vehicle. Moreover, in some examples, the threshold level of frequency of the blinking of the one or more warning lights 208 may correspond to a level designed to improve the detection of the light from the one or more warning lights 208 by, e.g., an assisted or autonomous driving system (e.g., an image-based assisted or autonomous driving system) of the following vehicle.

Moreover, at least some of the thresholds which may be utilized by the ECU 202 to determine that there is a prescribed condition for providing the rear-end collision mitigation alert as described herein (e.g., relating to TTC, rate of deceleration, and/or a level of instantaneous force applied on a brake pedal) may be learned by the subject vehicle. That is, the ECU 202 may monitor and track, e.g., braking data detected by a brake sensor as well as other sensor data including image data, location data, and/or inertial data (e.g., related, respectively, to how hard the driver of the subject vehicle presses down on the brake pedal and at what TTC or distance to an object). The ECU 202 may learn such braking behavior of the driver while the driver is driving the subject vehicle and predict that the driver may apply a given level of force on the brake pedal at a given TTC to, e.g., utilize this TTC as the threshold TTC value to determine that there is a prescribed condition for providing the rear-end collision mitigation alert (i.e., in addition or as an alternative to a manufacturer setting). Further, the ECU 202 may communicate such information with a remote server (e.g., via a network access device similar to the network access device 110 shown in and described herein with respect to FIG. 1) to provide the collected braking behavior related data from the subject vehicle to the remote server (as well as the relevant threshold TTC value) and/or receive a threshold TTC value associated with the same driver (e.g., from driving a different vehicle) or the same vehicle or vehicle type as the subject vehicle from the remote server. That is, the remote server may communicate with other vehicles to collect data relating to the braking behavior associated with other vehicles and/or drivers which may be stored on the remote server and used to provide, e.g., a threshold TTC value for a subject vehicle to utilize to determine whether to trigger or activate the rear-end collision mitigation alert.

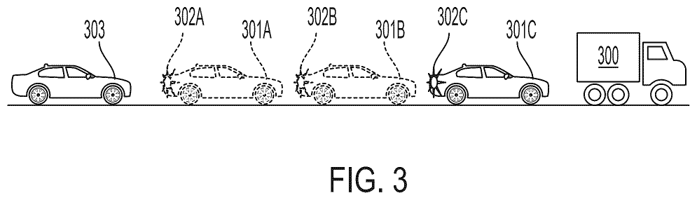

FIG. 3 is an illustration of an example scenario for automatically providing a rear-end collision mitigation alert on a vehicle. The example scenario includes a preceding vehicle 300, a subject vehicle 301 (collectively referring to the subject vehicle at the first, second, or third position 301A, 301B, or 301C), and a following vehicle 303. The subject vehicle 301 may be the same as or similar to the vehicle 100 shown in and described herein with respect to FIG. 1. The subject vehicle 301 may include a set of warning lights 302 (collectively referring to the set of warning lights 302A, 302B, or 302C on the subject vehicle at the respective first, second, or third position 301A, 301B, or 301C) which may be similar to or include or have the one or more light emitting apparatuses 142 shown in and described herein with respect to FIG. 1).

In the illustrated scenario, the preceding vehicle 300 may come to a sudden stop. An ECU (e.g., similar to the ECU 102 and the ECU 202 shown in and described herein with respect to FIGS. 1 and 2, respectively) on the subject vehicle 301 may determine a TTC to the stopped preceding vehicle 300, a deceleration rate of the subject vehicle 301, and/or a level of instantaneous force applied on a brake pedal on the subject vehicle 301 based on sensor data as described herein with respect to FIG. 2. With respect to the subject vehicle at the first position 301A, the ECU on the subject vehicle 301 may determine that the determined TTC, the determined deceleration rate, and/or the determined level of instantaneous force applied on the brake pedal are, respectively, less than a threshold TTC value, greater than a threshold deceleration rate, and/or greater than a threshold level of instantaneous force applied on the brake pedal described herein with respect to FIG. 2. Then, the ECU on the subject vehicle 301 may determine that the prescribed condition for providing the rear-end collision mitigation alert on the subject vehicle 301 is satisfied after, e.g., determining a sufficient condition for triggering or activating a forward-collision warning system as described herein with respect to FIG. 2, and cause the set of warning lights 302 to blink at a predetermined frequency to provide the rear-end collision mitigation alert as described herein.

As the subject vehicle 301 starts to slow down aggressively or comes to a stop which is performed by the driver-initiated brake pedal actuation/activation and/or an autonomous system activating the brake(s) to avoid a collision with the preceding vehicle 300, the rear-end collision mitigation alert would be triggered, causing the set of warning lights 302 on the subject vehicle 301 to blink at the predetermined frequency as described herein with respect to FIG. 2. The following vehicle 303 or the driver of the following vehicle 303 may be able to detect or see the set of warning lights 302 blinking at the predetermined frequency on the subject vehicle 301 to determine that the preceding vehicle 300 may be coming to a sudden stop, aggressively slowing down, or performing an unexpected maneuver (resulting in, e.g., the aggressive slowing down or stopping of the subject vehicle 301) and thus be able to begin to react earlier than the following vehicle 303 or the driver of the following vehicle 303 would without the set of warning lights 302 blinking to provide the rear-end collision mitigation alert. In this way, the rear-end collision mitigation alert described herein can allow the following vehicle 303 or the driver of the following vehicle 303 to safely brake or perform evasive maneuver(s) earlier than otherwise would have been possible without such notice to avoid or mitigate any potential rear-ending of the subject vehicle 301.

The subject vehicle 301 may trigger or activate, e.g., a pre-brake assistance at the second position (see 301B) and a panic braking at the third position (see 301C) as described herein with respect to FIG. 2. In some embodiments, the rear-end collision mitigation alert on the subject vehicle 301 may be triggered or activated at or just before the second position (see 301B—e.g., when the forward-collision warning system is not available on the subject vehicle 301) or at or just before the third position (see 301C—e.g., when the forward-collision warning system and the pre-brake assistance are not available on the subject vehicle 301).

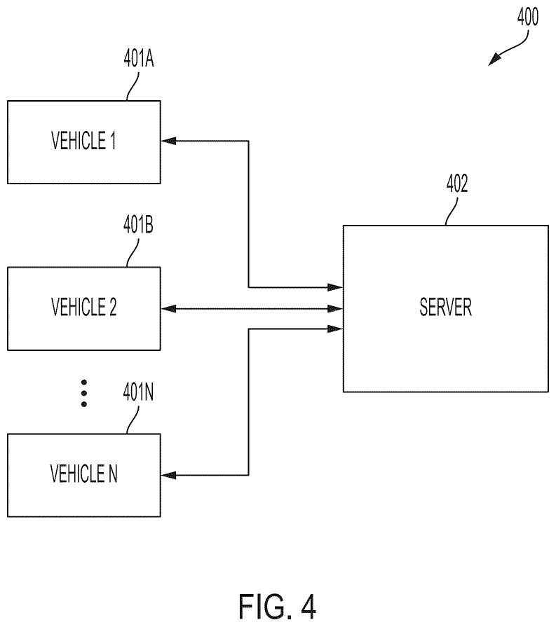

FIG. 4 is a block diagram illustrating a system 400 for automatically providing a rear-end collision mitigation alert on a vehicle. The system 400 may include a server 402 (e.g., similar to the remote server described herein with respect to FIG. 2) and a plurality of vehicles 401A-N (which may be collectively referred to herein as a vehicle 401 or vehicles 401—each of the plurality of vehicles 401A-N may be similar to the vehicle 100 shown in and described herein with respect to FIG. 1). The server 402 may be in data communication with the vehicles 401. The data communication may be, e.g., wireless (i.e., the data communication being provided by any type of wireless connection known in the art such as, for example, Bluetooth, Wi-Fi, a cellular network, etc.).

As described herein with respect to FIG. 2, the server 402 may be a remote server located remotely from the vehicles 401. For example, the server 402 may be a cloud server configured to communicate with the vehicles 401 to collect and store braking behavior related data (as well as, e.g., threshold TTC values for determining corresponding conditions for providing rear-end collision mitigation alerts on the vehicles 401) corresponding to various drivers and/or vehicles or vehicle types. The collected data may be categorized by the drivers and/or vehicles or vehicle types and stored on the server 402. Moreover, the server 402 may provide the appropriate or requested threshold TTC values corresponding to a requesting driver or vehicle from one or more of the vehicles 401.

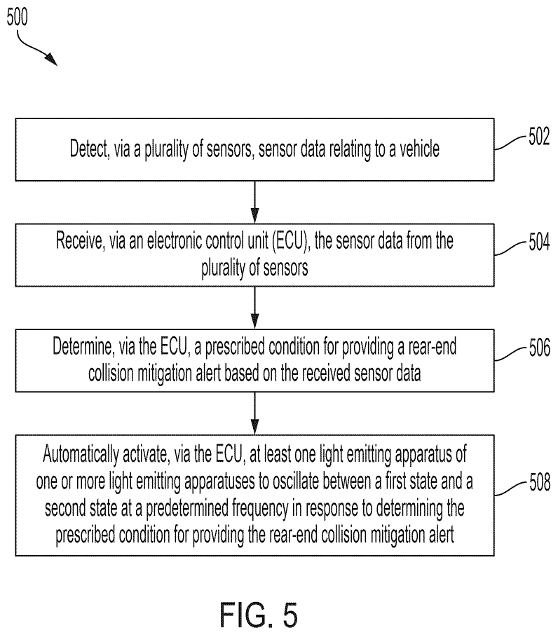

FIG. 5 is a flowchart of a method 500 for automatically providing a rear-end collision mitigation alert on a vehicle. The method 500, at least in part, may be implemented via a plurality of instructions (e.g., a software program) stored on a memory (e.g., similar to the memory 104 shown in and described herein with respect to FIG. 1) and accessed and processed by a processor (e.g., similar or connected to or as part of the ECU 102 shown in and described herein with respect to FIG. 1) to perform the various steps of the method 500.

The method 500 may include detecting, via a plurality of sensors, sensor data relating to the vehicle (step 502). Then, the method 500 may include receiving, via an electronic control unit (ECU), the sensor data from the plurality of sensors (step 504). In step 506, the method 500 may include determining, via the ECU, a prescribed condition for providing the rear-end collision mitigation alert based on the received sensor data as described herein, e.g., with respect to FIG. 2. The method 500 may then include automatically activating, via the ECU, at least one light emitting apparatus of one or more light emitting apparatuses to oscillate between a first state and a second state at a predetermined frequency in response to determining the prescribed condition for providing the rear-end collision mitigation alert (step 508).

In some embodiments, the method 500 may also include activating, via the ECU, a panic braking configured to apply a maximum level of instantaneous braking force on the vehicle, a pre-brake assistance configured to apply a predetermined level of instantaneous braking force less than the maximum level of instantaneous braking force on the vehicle, and/or a forward-collision warning system configured to predict a forward collision of the vehicle with an object within a predetermined amount of time and to provide a warning notification via an output device coupled to the ECU. For example, activating the panic braking, the pre-brake assistance, or the forward-collision warning system may include activating the panic braking, the pre-brake assistance, or the forward-collision warning system simultaneously with automatically activating the at least one light emitting apparatus to oscillate between the first state and the second state at the predetermined frequency, respectively, when the forward-collision warning system and the pre-brake assistance are not available, when the forward-collision warning system is not available, or when forward-collision warning system is available. In some examples, activating the panic braking, the pre-brake assistance, and/or the forward-collision warning system may include activating the panic braking, the pre-brake assistance, and/or the forward-collision warning system immediately after automatically activating the at least one light emitting apparatus to oscillate between the first state and the second state at the predetermined frequency, respectively, when the forward-collision warning system and the pre-brake assistance are not available, when the forward-collision warning system is not available, or when forward-collision warning system is available. The settings for the timing of the activation of the at least one light emitting apparatus to oscillate between the first state and the second state at the predetermined frequency (i.e., the activation of the rear-end collision mitigation alert) may be adjusted. In some embodiments, such settings may only be adjusted, e.g., at a manufacturer-approved site (e.g., by a manufacturer-approved equipment)—i.e., not by an end-user.

Where used throughout the specification and the claims, “at least one of A or B” includes “A” only, “B” only, or “A and B.” Exemplary embodiments of the apparatuses, the systems, and the methods described herein have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments (e.g., including a singular element where multiple elements are described and/or multiple elements where a singular element is described, etc.) that reasonably fall within the scope of the advancement to the art hereby contributed, and that that scope shall not be restricted, except in light of the appended claims and their equivalents.

What is claimed is:

1. A system for automatically providing a rear-end collision mitigation alert on a vehicle, the system comprising:
a plurality of sensors configured to detect sensor data relating to the vehicle;
one or more light emitting apparatuses configured to emit light; and
an electronic control unit (ECU) coupled to the plurality of sensors and the one or more light emitting apparatuses and configured to:
receive the sensor data from at least one sensor of the plurality of sensors; and
automatically activate at least one light emitting apparatus of the one or more light emitting apparatuses to oscillate between a first state and a second state at a predetermined frequency based on the sensor data indicating a prescribed condition for providing the rear-end collision mitigation alert.

2. The system of claim 1, wherein the ECU is further configured to:
determine a time to collision (TTC) of the vehicle with an object based on the sensor data; and
determine that the sensor data indicates the prescribed condition based on the determined TTC being less than a threshold value.

3. The system of claim 1, wherein the ECU is further configured to:
determine a rate of deceleration of the vehicle based on the sensor data; and
determine that the sensor data indicates the prescribed condition based on the determined rate of deceleration of the vehicle being greater than a threshold rate of deceleration.

4. The system of claim 1, wherein the ECU is further configured to:
determine a level of instantaneous force applied on a brake pedal on the vehicle; and
determine that the sensor data indicates the prescribed condition based on the determined level of instantaneous force applied on the brake pedal on the vehicle being greater than a threshold level.

5. The system of claim 1, wherein the ECU is further configured to:
determine a time to collision (TTC) of the vehicle with an object based on the sensor data;
determine a rate of deceleration of the vehicle based on the sensor data;
determine a level of instantaneous force applied on a brake pedal on the vehicle based on the sensor data; and
determine that the sensor data indicates the prescribed condition based on at least one of:
the determined TTC being less than a threshold value,
the determined rate of deceleration of the vehicle being greater than a threshold rate of deceleration, or
the determined level of instantaneous force applied on the brake pedal on the vehicle being greater than a threshold level.

6. The system of claim 1, wherein the plurality of sensors include at least one of an image sensor configured to detect image data, a location sensor configured to detect location data, an inertial measurement unit (IMU) sensor configured to detect inertial data, or a brake sensor configured to detect braking data including a level of instantaneous force applied on a brake pedal on the vehicle.

7. The system of claim 6, wherein the ECU is further configured to determine that the sensor data indicates the prescribed condition for providing the rear-end collision mitigation alert based on at least one of the image data, the location data, the inertial data, or the braking data.

8. The system of claim 1, wherein the first state and the second state of the at least one light emitting apparatus are an on state corresponding to the light being emitted and an off state corresponding to the light not being emitted, respectively.

9. The system of claim 1, wherein:
the at least one light emitting apparatus in the first state is configured to emit a light of a first level of brightness, and
the at least one light emitting apparatus in the second state is configured to emit a light of a second level of brightness different from the first level of brightness.

10. An apparatus for automatically providing a rear-end collision mitigation alert on a vehicle, the apparatus comprising:
one or more light emitting apparatuses configured to emit light; and
a controller electrically coupled to the one or more light emitting apparatuses and configured to:
receive an activation signal indicative of an instruction to activate at least one light emitting apparatus of the one or more light emitting apparatuses to oscillate between a first state and a second state at a predetermined frequency to provide the rear-end collision mitigation alert, and
automatically activate the at least one light emitting apparatus to oscillate between the first state and the second state at the predetermined frequency to provide the rear-end collision mitigation alert in response to the received activation signal.

11. The apparatus of claim 10, wherein the first state and the second state of the at least one light emitting apparatus are an on state corresponding to the light being emitted and an off state corresponding to the light not being emitted, respectively.

12. The apparatus of claim 10, wherein:
the at least one light emitting apparatus in the first state is configured to emit a light of a first level of brightness, and
the at least one light emitting apparatus in the second state is configured to emit a light of a second level of brightness different from the first level of brightness.

13. The apparatus of claim 10, wherein the predetermined frequency is based on a manufacturer setting.

14. The apparatus of claim 10, wherein the predetermined frequency is at least a threshold level of frequency.

15. The apparatus of claim 10, wherein the predetermined frequency is at least 4 hertz.

16. The apparatus of claim 10, wherein the controller is in data communication with a remote server and further configured to receive data including the predetermined frequency from the remote server.

17. A method for automatically providing a rear-end collision mitigation alert on a vehicle, the method comprising:
detecting, via a plurality of sensors, sensor data relating to the vehicle;
receiving, via an electronic control unit (ECU), the sensor data from the plurality of sensors;
determining, via the ECU, a prescribed condition for providing the rear-end collision mitigation alert based on the received sensor data; and
automatically activating, via the ECU, at least one light emitting apparatus of one or more light emitting apparatuses to oscillate between a first state and a second state at a predetermined frequency in response to determining the prescribed condition for providing the rear-end collision mitigation alert.

18. The method of claim 17, further comprising:
activating, via the ECU, a panic braking configured to apply a maximum level of instantaneous braking force on the vehicle, a pre-brake assistance configured to apply a predetermined level of instantaneous braking force less than the maximum level of instantaneous braking force on the vehicle, or a forward-collision warning system configured to predict a forward collision of the vehicle with an object within a predetermined amount of time and to provide a warning notification via an output device coupled to the ECU.

19. The method of claim 18, wherein:
activating the panic braking, the pre-brake assistance, or the forward-collision warning system includes activating the panic braking, the pre-brake assistance, or the forward-collision warning system simultaneously with automatically activating the at least one light emitting apparatus to oscillate between the first state and the second state at the predetermined frequency.

20. The method of claim 18, wherein:
activating the panic braking, the pre-brake assistance, or the forward-collision warning system includes activating the panic braking, the pre-brake assistance, or the forward-collision warning system immediately after automatically activating the at least one light emitting apparatus to oscillate between the first state and the second state at the predetermined frequency.
